(19) United States
(12) Patent Application Publication
(10) Pub. No.: US 2012/0023134 A1
(43) Pub. Date: Jan. 26, 2012

(54) PATTERN MATCHING DEVICE, PATTERN MATCHING METHOD, AND PATTERN MATCHING PROGRAM

(75) Inventor: Hiroyoshi Miyano, Tokyo (JP)

(73) Assignee: NEC Corporation, Tokyo (JP)

(21) Appl. No.: 13/260,672

(22) PCT Filed: Mar. 15, 2010
(86) PCT No.: PCT/JP2010/054737

§ 371 Date: Sep. 27, 2011

(30) Foreign Application Priority Data
Mar. 27, 2009 (JP) 2009-080532

(51) Int. Cl. G06F 17/30

(52) U.S. Cl. 707/776; 707/E17.014

(57) ABSTRACT

An optimal subspace for a distance or a similarity cannot be obtained by a pattern matching device which obtains a subspace independent from the distance or the similarity used for matching. A pattern matching device includes a feature extraction unit for extracting a feature value by lowering the dimension of data using a feature extraction parameter; a calculation unit for calculating a distance or a similarity of the data to be matched using the feature value; and a parameter updating unit for comparing the distance or the similarity, and updating the feature extraction parameter so that the value of the distance or the similarity becomes closer to a matching result regarding whether or not the values of the distance or the similarity are in the same category.

### TECHNICAL FIELD

The present invention relates to a pattern matching device, a pattern matching method, and a pattern matching program for pattern matching for facial image.

### BACKGROUND ART

In the face matching, the face matching approach based on subspace method is widely used and recognized as useful one.

A matching method based on subspace method transforms input information into the lower dimensional information than the input information by performing the matrix transformation to the input facial image information which is input, and calculates distance or similarity ratio of the low dimensional input information. And when the distance is small or the similarity ratio is large, the matching method based on a subspace method is the matching processing method which judges that said input information is the information of the same persons.

As a technique based on this approach, various techniques such as PCA (Principal Component Analysis) [non-patent document 1], LDA (Linear Discriminant Analysis) [non-patent document 2] and the respective expansion methods [non-patent document 3 and non-patent document 4] are used.

For example, a technique based on PCA searches a subspace with large variance. LDA searches for the subspace which maximizes the interclass variance/in-class variance. Anyway, after searching for a subspace, the identification processing in PCA or LDC sets the function separately that calculates some distance and similarity ratio such as the Euclidean distance or the normalized correlation value, and judges whether the persons are same or not based on the value of the distance or similarity ratio.

[Non-patent document 1] M. A. Turk and A. P. Pentland, “Face recognition using eigenfaces” Proc. of IEEE CVPR, pp. 586-591, June and 1991.

[Non-patent document 2] P. N. Belhumeur, J. P. Hespanha, and D. J. Kregman and “Eigenfaces vs. Fisherfaces: Recognition using class specific linear projection” IEEE Trans. Pattern Anal. Machine Intell., VOL. 19, pp. 711-720, May 1997

[Non-patent document 3] X. Jiang, B. Mandal, and A Kot, Eigencharacteristics Regularization and Extraction in Face Recognition, IEEE TRANSACTION ON PATTERN ANALYSIS AND MACHINE INTELLIGENCE, vol 30, no. 3, pp. 383-394 and 2008.

[Non-patent document 4] Sang-Ki Kim, Kar-Ann Toh, and Sangyoun Lee, “SVM-based Discriminant Analysis for face recognition”, Industrial Electronics and Applications, 2008. ICIEA 2008. 3rd IEEE Conference on 3-5, pp. 2112-2115, June 2008.

[Non-patent document 5] C. Liu and H. Wechsler, “Gabor characteristics Based Classification Using the Enhanced Fisher Linear Discriminant Analysis for Face Recognition”, IEEE Trans. Image Processing, vol. 11, no. 4, pp. 467-476 and 2002.

[Non-patent document 6] “Pattern Classification” Author: Peter E. Hart, and David G. Stork Richard O. Duda, (Translation supervised by Morio Onoe), Publisher: New Technology Communications, 2001/07 (ISBN 4-915851-24-9) and pp 311-312

[Non-patent document 7] Keinosuke Fukunaga, Introduction to Statistical Pattern Recognition Second Edition and pp 76

[Non-patent document 8] “Pattern Classification” Author: Peter E. Hart, and David G. Stork Richard O. Duda, (Translation supervised by Morio Onoe), Publisher: New Technology Communications, 2001/07 (ISBN 4-915851-24-9) and pp 21-26

### DISCLOSURE OF INVENTION

### Problem which Invention Tries to Settle

However, because the technology of the non-patent document 1 and so on is a technique to search for the subspace which is not based on the distance or the similarity ratio for the matching, the most suitable subspace to the distance or the similarity ratio to be used for matching cannot be searched. As a result, the technology of the non-patent document 1 and so on cannot sufficiently get the precision of the pattern matching of the facial matching.

For example, the suitable subspace for the facial matching must not be always the same between the case that the distance and the similarity ratio for the matching are the Euclidean distance and the case that they are the normalized correlation value. However, because the technology of a non-patent document 1 and so on calculates a same subspace, the good precision cannot be obtained.

Accordingly, the object of the present invention which is considered to settle the problem mentioned above is to provide the pattern matching device which learns the subspace according to the distance and the similarity ratio used for matching.

### Means for Settling a Problem

A pattern matching device according to the present invention includes characteristics extraction means for extracting the characteristics value by dimensional reduction of data using a characteristics extraction parameter, calculating means for calculating a distance or a similarity ratio of the data to be matched using said characteristics value, and parameter updating means for updating said characteristics extraction parameter so that the value of said distance or similarity ratio may approach to the matching result indicating whether said distance or similarity ratio is the same category or not, by comparing said distance or similarity ratio.

A pattern matching method according to the present invention, comprising extracting the characteristics value by dimensional reduction of data using a characteristics extraction parameter, calculating a distance or a similarity ratio of the data to be matched using said characteristics value, and updating said characteristics extraction parameter so that the value of said distance or similarity ratio may approach to the matching result indicating whether said distance or similarity ratio is the same category or not, by comparison of said distance or similarity ratio.

A program according to the present invention making a computer works as: an executing process for extracting the characteristics value by dimensional reduction of the data for using a characteristics extraction parameter, calculating process for calculating a distance or a similarity ratio of the data to be matched using said characteristics value, and updating process for updating said characteristics extraction parameter so that the value of said distance or similarity ratio may approach to the matching result indicating whether said distance or similarity ratio is the same category or not, by comparison of said distance or similarity ratio.

### THE EFFECT OF THE INVENTION

Because the parameter which extracts a subspace according to the distance and the similarity ratio used for matching can be improved based on learning, the pattern matching performance can be improved based on the present invention.

### BRIEF DESCRIPTION OF THE DRAWINGS

FIG. 1 is a configuration diagram of a pattern matching device according to the exemplary embodiment of the present invention.

FIG. 2 is a flowchart of the pattern matching device according to the exemplary embodiment of the present invention.

FIG. 3 is a flowchart of the pattern matching device according to the exemplary embodiment of the present invention.

FIG. 4 is a configuration diagram of a pattern matching device according to the exemplary embodiment of the present invention.

### DESCRIPTION OF A CODE

11 Data registration unit.
12 Characteristics extraction unit.
13 Distance/similarity ratio calculation unit.
14 Parameter updating unit.
15 Data matching unit.
16 Result output unit.
21 Characteristics extraction parameter storage unit.

### THE BEST FORM FOR CARRYING OUT THE INVENTION

Next, the best form for carrying out the invention will be described in detail with reference to drawings.

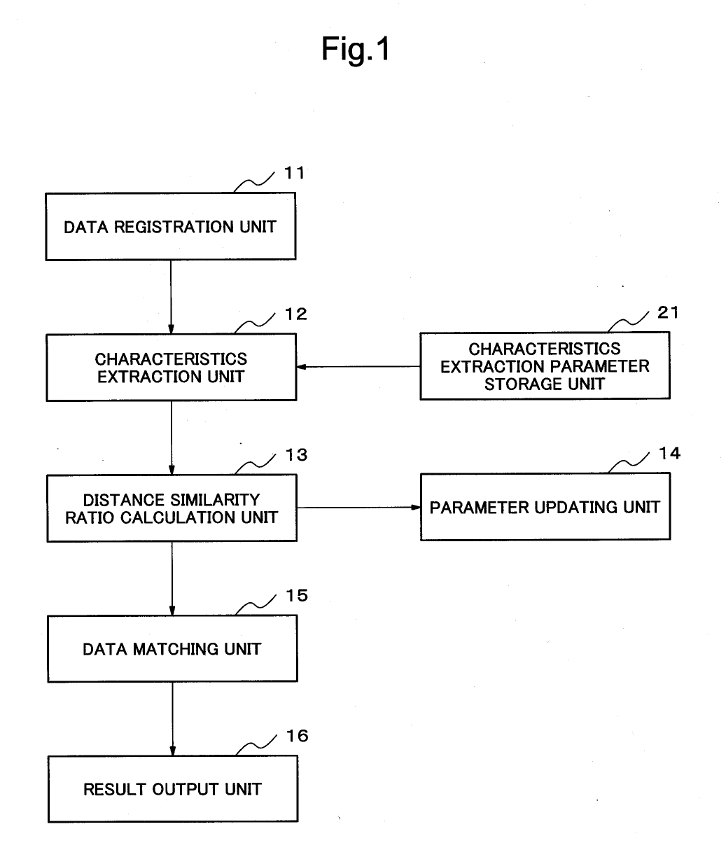

FIG. 1 is a configuration diagram of a pattern matching device in the exemplary embodiment of the present invention. The pattern matching device includes a data registration unit 11, a characteristics extraction unit 12, a distance/similarity ratio calculation unit 13, a parameter updating unit 14, a data matching unit 15, a result output unit 16, and a characteristics extraction parameter storage unit 21.

The data registration unit 11 registers a set of the image data of pattern such as the facial image data in advance. And the data registration unit 11 outputs the set of those image data and another set of the image data of pattern such as the facial image data to be matched to the characteristics extraction unit 12. Although the description is concretely limited to the facial image data case hereafter, the image data of arbitrary pattern such as the images of human body, animal, and object can be replaced from the facial image in the following description of the present invention.

And the data registration unit 11 represents the set of the facial image data registered in the data registration unit 11 as the set x⁽¹⁾ᵢ (i=1, . . . , N₁) of the D dimension vector. And the data registration unit 11 represents the set of the facial image data to be matched as the set x⁽²⁾ⱼ (j=1, . . . , N₂) of the D dimension vector. The set of said registered facial image data and the set of the facial image data to be matched may be the same set.

A representation method when the data registration unit 11 represents the facial image data by the D dimension vector, for example, may use the vector which is represented by changing the facial image data into the same sizes of image data of which the number of pixel is D, and arranging the gradation values of said image data of which the number of pixel is D one by one. Or, the data registration unit 11 performs the characteristics extraction processing such as Gabor filtering described in non-patent document 5 to the facial image data, and generates the vector arranging the result of D pieces obtained.

The characteristics extraction unit 12 extracts the characteristics value based on transforming the vector representing the facial image data input from said data registration unit 11 to the lower dimensional vector by using the characteristics extraction parameter stored in the characteristics extraction parameter storage unit 21.

Concretely, the characteristics extraction unit 12 obtains the vectors z⁽¹⁾ᵢ (i=1, . . . , N₁) and z⁽²⁾ⱼ (j=1, . . . , N₂) whose dimension D′ is smaller than the dimension of the data input from data registration unit 11 by calculating the following matrix transformations,

z⁽¹⁾ⱼ=Ax⁽¹⁾ᵢ(i=1, . . . , N₁)

z⁽²⁾ⱼ=Ax⁽²⁾ⱼ(j=1, . . . , N₂)

using the data x⁽¹⁾ᵢ (i=1, . . . , N₁) and x⁽²⁾ⱼ (j=1, . . . , N₂) represented by D dimension vector which are input from said data registration unit 11 and the characteristics extraction parameter A which is represented by the D′ x D matrix (dimension of D′<=(less-than or equal) dimension of D) stored in the characteristics extraction parameter storage unit 21.

The distance/similarity ratio calculation unit 13 calculates a distance or a similarity ratio using the vector (characteristics value) which represents the facial image data after the transformation obtained by the characteristics extraction unit 12. The distance is a value which is expected to get smaller when the facial data that the matched vector represents are those of the same persons and to get larger when they are not the same persons. More, the similarity ratio is the value which is expected to get larger when the facial data that the matched vector represents are those of the same persons and to get smaller when they are not the same persons.

Concretely, the distance/similarity ratio calculation unit 13 calculates the distance and the similarity ratio for judging whether the facial image data represented by D′ dimension vectors z⁽¹⁾ⱼ and z⁽²⁾ⱼ that are obtained in the characteristics extraction unit 12, are those of the same persons or not. As the distance/similarity ratio used here, for example, the Euclidean distance

dᵢⱼ=|z⁽¹⁾ᵢ−z⁽²⁾ⱼ|

of said vectors z⁽¹⁾ᵢ and z⁽²⁾ⱼ will be calculated. More the distance/similarity ratio calculation unit 13 may calculate the normalized correlation value

rᵢⱼ=z⁽¹⁾ᵢz⁽²⁾ⱼ/|z⁽¹⁾ᵢ∥z⁽²⁾ⱼ|

that is one of the criterions representing the similarity ratio instead of using said Euclidean distance. Or, the distance/similarity ratio calculation unit 13 may use the other distance criterions or similarity ratios criterion such as L1 distance in stead of said Euclidean distance and the normalized correlation value.

The parameter updating unit 14 updates the characteristics extraction parameter A stored in the characteristics extraction parameter storage unit 21 by using the facial image data registered in the data registration unit 11 and the value of the distance or the value of the similarity ratio obtained in the distance/similarity ratio calculation unit 13. The parameter updating unit 14 updates the characteristics extraction parameter A so that the distance is smaller or the similarity ratio is larger in the case of same persons case, while the distance is larger or the similarity ratio is smaller in case of the non-same persons for the more precise matching result at the data which the distance/similarity ratio calculation unit 13 calculates the distance or the similarity ratio.

Concretely, the parameter updating unit 14 represents the probability that the person whom input x⁽¹⁾ᵢ indicates and the person whom input x⁽²⁾ⱼ indicates are same persons by using x⁽¹⁾ᵢ, x⁽²⁾ⱼ, the characteristics extraction parameter A, and the parameters a, b, c. When said probability is defined as Pᵢⱼ(x⁽¹⁾ᵢ, x⁽²⁾ⱼ; A, a, b, c), the parameter updating unit 14 calculates the characteristics extraction parameter A and the parameters a, b, c which give the maximum value of S calculated by

S=πPᵢⱼ·π(1−Pᵢⱼ)

x⁽¹⁾ᵢ and x⁽²⁾ⱼ are same persons x⁽¹⁾ᵢ and x⁽²⁾ⱼ are different persons.

Base on this, the parameter updating unit 14 can obtain the characteristics extraction parameter A and the parameters a, b, c which cause that the matching result of said input x⁽¹⁾ᵢ and x⁽²⁾ⱼ is more precise result. Namely, the parameter updating unit 14 calculates parameters by performing maximum likelihood estimation to the posterior probability whether they are the same persons or not.

And, yᵢⱼ is defined as y=1 in the case that input x⁽¹⁾ᵢ and x⁽²⁾ⱼ are the same persons, and, otherwise, defined y=−1 for arbitrary i and j, the parameter updating unit 14 may calculate the characteristics extraction parameter A and the parameters a, b, c so that it gets the logarithm of both side, reverses signs, and makes S′

S′=−log S=−Σyᵢⱼ log Pᵢⱼ

minimize in stead of S value that is the maximum likelihood estimation to the logarithm likelihood is operated.

Or, in order to calculate parameters a, b, c stably, the parameter updating unit 14 may add the term of weight decay described in the non-patent document 6, and establish S′

S′=−log S=−Σyᵢⱼ log Pᵢⱼ+C(a²+b²+c²)

by using a predetermined constant C′, and minimize S′. Or, the parameter updating unit 14 may establish S′

S′=−log Sᵢⱼ=−Σyᵢⱼ log Pᵢⱼ+Cₐa²+C_{b}b²+C_{c}c²

using predetermined constants Cₐ, C_{b}, C_{c} more in detail.

As a concrete numerical formula of Pᵢⱼ, the parameter updating unit 14 may use the logistic regression method simply. That is, the parameter updating unit 14 may calculate the probability Pᵢⱼ

$${P}_{ij} = \frac{1}{1 + {e}^{( {ad}_{ij} + c )}}$$

by setting the value of the distance or the similarity ratio to be dᵢⱼ.

Or, for example, when the distance/similarity ratio calculation unit 13 uses Euclidean distance dᵢⱼ, the parameter updating unit 14 may define the probability as

$${P}_{ij} = \frac{1}{1 + {e}^{( {ad}_{ij} + {blogd}_{ij} + c )}} , {d}_{ij} = \vert {Ax}_{i} - {Ax}_{j} \vert$$

For example, as described in non-patent document 7, the distribution which has the positive value like the distance is employed the process as analyzing after modeling by the gamma-distribution. Based on using the modeling by said gamma-distribution, the parameter updating unit 14 can also calculate said probability Pᵢⱼ. That is, the parameter updating unit 14 represents the distribution of d in case of the same persons with the gamma-distribution

p1=C₁×^{β1}e^{-α1d}

(Here, C₁ is a predetermined constant, α1, β1 are parameters of the gamma-distribution),

represents the distribution of d in case of the non-same persons with other gamma-distribution

p1=C₂×^{β2}e^{-α2d}

(Here, C₂ is a predetermined constant, α1, β1 are the parameters of gamma-distribution),

make the prior probability (constant) of the same persons P₁ and the prior probability (constant) of non-same persons P₂, for example, according to the Bayes's theorem shown in non-patent document 8, can calculate the posterior probability Pᵢⱼ which is judged the same persons as

$$\begin{matrix}{P}_{ij} = \frac{{p}_{1} {P}_{1}}{{p}_{1} {P}_{1} + {p}_{2} {P}_{2}} \\ = \frac{1}{1 + {e}^{( - lo {gp}_{1} + lo {gp}_{2} - {logP}_{1} + {logP}_{2} )}} \\ = \frac{1}{1 + {e}^{( ad + blogd + c )}} .\end{matrix}$$

And the parameter updating unit 14 can get the same numerical formula as said representation. However, the parameter updating unit 14 replaces the parameters as follows.

a=α₁−α₂,b=−(β₁−β₂),c=−(log C₁P₁−log C₂P₂).

The parameter updating unit 14 can use the same numerical formula as the above even in the case that the other distance criterion such as L1 distance, for example, is used in stead of said Euclidean distance.

Or, because the seeming of same persons becomes large when the distance is small while the seeming of same persons becomes large when the similarity ratio is large in the case of the similarity ratio, the parameter updating unit 14 may reverse the sign and, for example, use the definition as

$${P}_{ij} = \frac{1}{1 + {e}^{( {as}_{ij} + {blogs}_{ij} + c )}} , {s}_{ij} = 1 - {r}_{ij} , {r}_{ij} = \frac{{Ax}_{i} \cdot {Ax}_{j}}{\vert {Ax}_{i} \vert \vert {Ax}_{j} \vert}$$

in the case of normalized correlation value rᵢⱼ in stead of said distance. Or, the parameter updating unit 14 may use the same numerical formula in the case of using the other similarity ratio such as inner product instead of the normalized correlation value.

Or, the parameter updating unit 14 may separately set the distribution suitable to the respective distance criterion or the similarity ratio in stead of the gamma-distribution and adopt one derived the numerical formula based on said Bayes's theorem.

The parameter updating unit 14 may substitute the distribution of the distance or the similarity ratio in the case that inputs x⁽¹⁾ᵢ and x⁽²⁾ⱼ occur at random as the representation of p2 which is the distribution of non-same persons.

For the calculation method of the parameters A, a, b, c at which S is maximum or S′ is minimum, the parameter updating unit 14 uses general various optimization methods. For example, the parameter updating unit 14 may use the predetermined constant α and presume by using a gradient method such as repeating the process as

$$A ← A - α \frac{\partial {S}^{′}}{\partial A}$$

$$a ← a - α \frac{\partial {S}^{′}}{\partial a}$$

$$b ← b - α \frac{\partial {S}^{′}}{\partial b}$$

$$c ← c - α \frac{\partial {S}^{′}}{\partial c} .$$

Or, the parameter updating unit 14 may use other optimization scheme such as Newton method or a conjugate gradient method.

Or, the parameter updating unit 14 may learn according to a framework of the probabilistic descent method in which x⁽¹⁾ᵢ and x⁽²⁾ⱼ are selected at random and parameters are one by one updated. In this case, when the inputs are given at random actually, there is a possibility that the convergence of learning of the parameter updating unit 14 slows. Then, in compensation, the parameter updating unit 14 may calculate the average value of the each characteristics quantity for person in advance respectively, and execute the probabilistic descent method with substituting the average value of the characteristics quantity of said person, which has been reckoned in advance represented by said characteristics quantity, either one of x⁽¹⁾ᵢ or x⁽²⁾ⱼ instead of using said characteristics as it is.

Or, the operation of the parameter updating unit 14 can considered such as the method that represents the characteristics extraction parameter A with the linear sum using weight parameter wₖ like this,

$$A = {\sum }_{k = 1}^{K} {w}_{k} {A}_{k}$$

by using predetermined K units of D′ x D matrixes Aₖ (k=1, . . . , K) instead of presuming the parameters of said characteristics extraction parameter A directly, and presumes the weight parameter wₖ instead of presuming the characteristics extraction parameter A directly. The number of parameters of characteristics extraction parameter A is D′ x D. However, when the characteristics extraction parameter A is represented by said linear sum, the parameter updating unit 14 may presume K pieces of parameters which represent characteristics extraction parameter A. Therefore, when the numbers N₁, N₂ of data used for presumption of characteristics extraction parameter A are few particularly, the parameter updating unit 14 can presume the parameters stably.

The parameter presumption of said weight parameter w in the parameter updating unit 14 is also similar as the parameter presumption method of said characteristics extraction parameter A and so on. That is, the parameter updating unit 14 may employ a gradient method, for example, as parameter presumption of weight parameter w and calculate as follows.

$${w}_{k} ← {w}_{k} - α \frac{\partial {S}^{′}}{\partial {w}_{k}}$$

As said matrix Aₖ, the parameter updating unit 14 may use one that is established

Aₖ=uₖuₖ^{T}(T represents transposition),

for example, by using eigenvector uₖ which is obtained after performing PCA to the whole data of x⁽¹⁾ᵢ and x⁽²⁾ⱼ, concretely. Or, the parameter updating unit 14 may use LDA and eigenvector uₖ obtained by various expansion methods of LDA instead of PCA.

Or, the parameter updating unit 14 may use the basis vector representing each axis in characteristics space of input x⁽¹⁾ᵢ and x⁽²⁾ⱼ which are D dimension vectors. In this case, the characteristics extraction parameter A is a matrix with the consideration of expansion and reduction of each axial scaling in characteristics space.

And, the parameter updating unit 14 may also add the term of weight Decay to said weight parameter wₖ and set as follows.

$${S}^{′} = - \sum {{y}_{ij}}_{i , j} log {P}_{ij} + {C}_{a} {a}^{2} + {C}_{b} {b}^{2} + {C}_{c} {c}^{2} + C {\sum }_{k = 1}^{K} {w}_{k}^{2}$$

The parameter updating unit 14 may make the form the first power as the term of weight Decay like this.

$${S}^{′} = - {\sum }_{i , j} {y}_{ij} log {P}_{ij} + {C}_{a} {a}^{2} + {C}_{b} {b}^{2} + {C}_{c} {c}^{2} + C {\sum }_{k = 1}^{K} \vert {w}_{k} \vert$$

The parameter updating unit 14 may change it with the shape of various terms using generally in weight Decay such as other exponential power terms.

The data matching unit 15 judges whether the matched facial image data are data of the same persons or not by using the distance or the similarity ratio obtained from the distance/similarity ratio calculation unit 13.

For example, when the distance value such as the Euclidean distance is obtained, the data matching unit 15 may perform the matching processing in which the person represented by input x⁽¹⁾ⱼ and the person represented by input x⁽²⁾ⱼ are same persons when dᵢⱼ<th and otherwise they are non-same persons using threshold value th predetermined for judging method.

Or, when the similarity ratio such as the normalized correlation value is used, data matching unit 15 may perform the matching processing in which the person represented by input x⁽¹⁾ⱼ and the person represented by input x⁽²⁾ⱼ are same persons when rᵢⱼ>th′ and otherwise they are non-same persons using threshold value th′ predetermined for judging method.

Or, instead of performing the threshold value processing, the data matching unit 15 may calculate rᵢⱼ for all i and judge that the person of input x⁽¹⁾ᵢ which corresponds the maximum i is the person represented by input x⁽²⁾ⱼ.

The result output unit 16 displays the matching result obtained in the data matching unit 15 on the computer monitor and saves the result in the disk. The output of the result output unit 16 is not limited such that the output of the result output unit 16 indicates successively whether inputs x⁽¹⁾ᵢ and x⁽²⁾ⱼ which are the objects of matching are the same persons or not on the monitor, for example.

The characteristics extraction parameter storage unit 21 stores the characteristics extraction parameter A, which is needed at the time when the characteristics extraction unit 12 executes the characteristics extraction processing, in such as the dictionary which the characteristics extraction parameter storage unit 21 has, for example. Concretely, the characteristics extraction parameter storage unit 21 stores the characteristics extraction parameter A which is said D′ x D matrix.

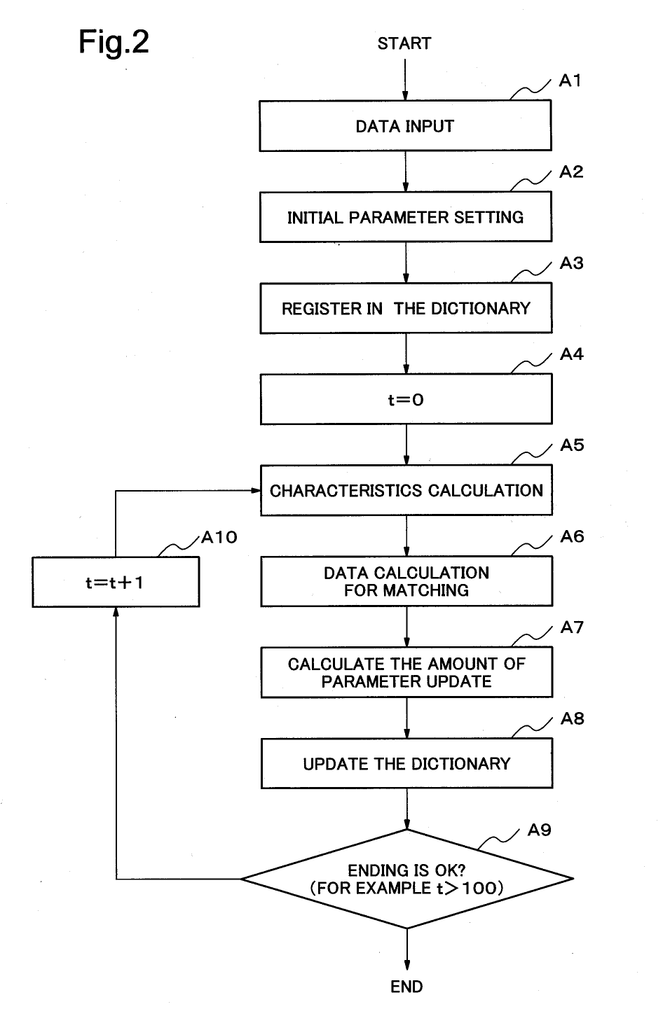

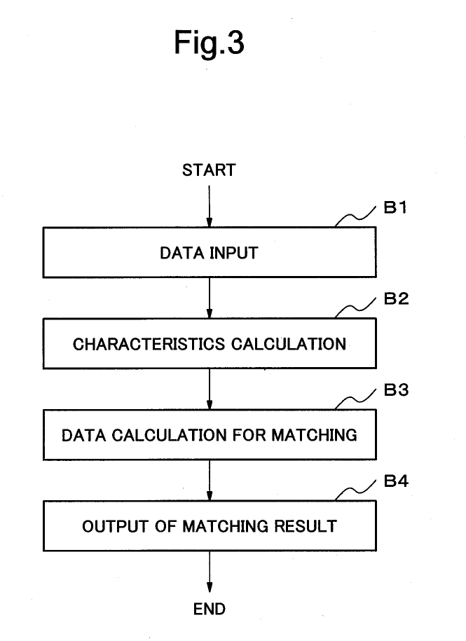

Next, the operation of the best exemplary embodiment for working the present invention will be described in detail with reference to FIG. 2 and FIG. 3.

First, in advance, a pattern matching device of the exemplary embodiment of the present invention needs to store appropriate characteristics extraction parameter A in the characteristics extraction parameter storage unit 21. The processing of a pattern matching device will be described in detail with reference to FIG. 2 including the processing for that.

The pattern matching device registers a large number of facial image data for the calculating characteristics extraction parameter A in the data registration unit 11 apart from the data to be used for the actual face matching (Step A1).

And, the characteristics extraction parameter storage unit 21 stores the value calculated from a large number of facial image data registered temporarily in a dictionary as the characteristics extraction parameter A (Steps A2 and A3). Concretely, as the characteristics extraction parameter A to be stored temporarily, for example, the characteristics extraction parameter storage unit 21 may store the characteristics extraction parameter A which is calculated based on the processing described in from non-patent document 1 to non-patent document 4 or the like to a data set of a entire large number of registered facial image data x⁽¹⁾ᵢ (i=1, . . . , N₁) and x⁽²⁾ⱼ (j=1, . . . , N₂).

Next, the pattern matching device of the present invention prepares variable t and sets 0 to variable t (Step A4). The variable t represents the number of executing times from processing Step A5 to Step A8, hereafter.

The characteristics extraction unit 12 which receives the facial data to be matched via the data registration unit 11 carries out the characteristics extraction processing using the characteristics extraction parameter A stored in the characteristics extraction parameter storage unit 21 (Step A5).

By using the characteristics value that the characteristics extraction unit 12 calculates in Step A5, the distance/similarity ratio calculation unit 13 calculates the distance or the similarity ratio of data to be matched (Step A6).

Next, the parameter updating unit 14 updates the characteristics extraction parameter A and the parameters a, b, c so as to approach to the more desirable value, based on the value of the distance or the similarity ratio obtained in Step A6 by using the distance/similarity ratio calculation unit 13 (Step A7). In case of the distance, the parameter updating unit 14 updates the characteristics extraction parameter A and so on, for becoming small in the case of same persons and becoming large in the case of non same persons. In case of the similarity ratio, the parameter updating unit 14 updates the characteristics extraction parameter A and so on, for becoming large in the case of same persons and becoming small in the case of non same persons.

Or, as initial values of the parameters a, b, c, said parameter updating unit 14 may set them at random for example or set them such as a=−1, b=0, c=0.5 for example. Or, the parameter updating unit 14 may update a, b, c before updating the characteristics extraction parameter A, derive the optimized a, b, c calculated using the characteristics extraction parameter A that are given at that time, and use them as initial values.

The parameter updating unit 14 stores the updated characteristics extraction parameter A and so on, in the characteristics extraction parameter storage unit 21 once again (Step A8).

The pattern matching device judges whether the processing may finish or not (Step A9). For example, the pattern matching device may finish with the judge that the sufficient number of times is processed if variable t of the number of processing times from Step A5 to Step A8 exceeds the predetermined constant th, and, otherwise, may not finish. Or, the pattern matching device executes the comparison with the values of said evaluation functions S and S′ before updating parameters and those values after updating parameters, and may finish with the judge that the change is enough small and, may not finish otherwise.

When it is judged that it does not finish in Step A9, the pattern matching device increases variable t by one (Step A10), the characteristics extraction unit 12 executes the characteristic calculation of Step A5 once again by using characteristics extraction parameter A which the parameter updating unit 14 updates in Step A8, and the processing are repeated. The pattern matching unit repeats the above mentioned processing until it will judge the finish in Step A9.

Next, the case of inputting the object data to be processed for matching actually will be described in detail with reference to FIG. 3.

The data registration unit 11 receives the data to be actually used for the facial matching as same as in Step A1 (Step B1).

Next, the characteristics extraction unit 12 performs the characteristics extraction processing using the characteristics extraction parameter A stored in the characteristics extraction parameter storage unit 21 as same as in Step A5 (Step B2).

The distance/similarity ratio calculation unit 13 performs the calculation processing of the distance or the similarity ratio for the matching which is the same as the calculation processing for the matching used in Step A6 (Step B3).

The data matching unit 15 performs the person judgment and the result output unit 16 outputs the matching result (Step B4).

In this way, the pattern matching device according to the exemplary embodiment can obtain the optimization effect for the subspace.

The reason is because the pattern matching device according to the exemplary embodiment can improve the parameter which extracts a subspace based on the learning according to the distance and the similarity ratio used for matching.

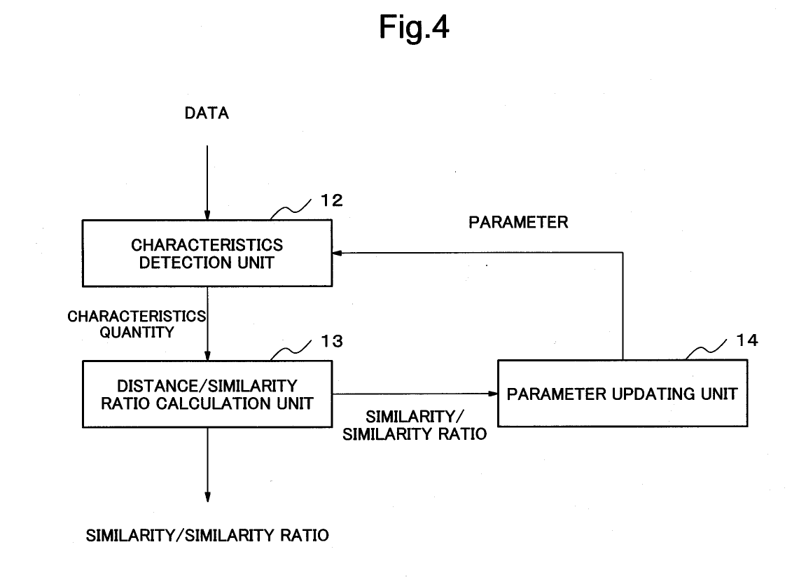

Further, the minimum configuration exemplary embodiment of the present invention can be composed of the characteristics extraction unit 12, the distance/similarity ratio calculation unit 13, and the parameter configuration part 14, and is also enabled to learn the subspace according to the distance and the similarity ratio that are used for matching, which is the effect of the present invention, in this minimum configuration as shown in FIG. 4.

Or, in a subspace, the space where each person data exists may be called a category of the person. When the data to be matched are the same persons, those data are the date of same category. And the distance of the data which belongs to a certain category and the data of the same category is shorter than the distance to the other category data. Similarly, the similarity ratio of the data which belongs to a certain category and the data of the same category becomes higher than the similarity ratio to other category data. Therefore, the parameter updating unit 14 and the data matching unit 15 can judge whether the matching data belongs to the same category or not from the distance or the similarity ratio.

And, the processing in which the parameter updating unit 14 makes the distance smaller or the similarity ratio larger in case of the same parsons is called the processing to approach a matching result of the same category. Or, the processing in which the parameter updating unit 14 makes the distance larger or the similarity ratio smaller in case of the non-same parsons is called the processing to approach a matching result of the non-same category.

### Example

Next, a concrete example for performing the present invention using FIG. 1 to FIG. 3 will be described.

The parameter matching unit of the example collects the facial image data of one thousand people with ten images per person apart from the image data to be matched for presuming the characteristics extraction parameter beforehand.

The data registration unit 11 makes the size of all facial image data 80×80 and normalizes the size so that the position of the right eye and the position of the left eye come to the same coordinate value.

The vector which lines the gradation value of these image data is represented as the vector of 80×80=6400 dimensions. The data registration units 11 set these vectors to xₖ (k=1, . . . , 1000×10). Moreover the data registration unit 11 makes xₖ (k=1, . . . , 1000×10) to x⁽¹⁾ᵢ=xᵢ (i=1, . . . , 1000×10) and x⁽²⁾ⱼ (j=1, . . . , 1000×10). In other words, the data registration unit 11 sets x⁽¹⁾ᵢ and x⁽²⁾ⱼ to the same value.

Next, with above-mentioned x, the pattern matching device of the example calculates the initial characteristics extraction parameter A using the LDS processing described in the non-patent document 2 and stores it in the dictionary of the characteristics extraction parameter storage unit 21 (Steps A2 and A3).

Next, the parameter matching unit of the example sets 0 to variable t (Step A4). The variable t represents the number of executing times from processing Step A5 to Step A8.

The characteristics extraction unit 12 which receives the facial image data to be matched performs the characteristics extraction processing using the characteristics extraction parameter A stored in the characteristics extraction parameter storage unit 21 (Step A5). Concretely, the characteristics extraction unit 12 calculates z⁽¹⁾ᵢ=z⁽²⁾ᵢ=Axᵢ(i=1, . . . , 1000×10).

Next the distance/similarity ratio calculation unit 13 calculates the normalized correlation values

rᵢⱼ=z⁽¹⁾ᵢz⁽²⁾ⱼ/|z⁽¹⁾ᵢ∥z⁽²⁾ⱼ|

for all of the combinations using the characteristics value z⁽¹⁾ᵢ and z⁽²⁾ⱼ obtained in Step A5 (Step A6).

The parameter updating unit 14 updates the parameters of the characteristics extraction parameter storage unit 21 so that the calculation result data for the matching which are calculated as the normalized correlation value obtained in Step A6 based on the distance/similarity ratio calculation unit 13 may approach to the more desirable value (Step A7). Concretely, the parameter updating unit 14 sets a=−1, b=0, c=0.5 in advance as the initial values of parameters a, b, c. And, the parameter updating unit 14 sets the constant value C as C=0.001 in advance, and in order to make S′ small which can be calculated as

$${S}^{′} = - log S = - {\sum }_{i , j} {y}_{ij} log {P}_{ij} + C ( {a}^{2} + {b}^{2} + {c}^{2} )$$

$${P}_{ij} = \frac{1}{1 + {e}^{( {as}_{ij} + {blogs}_{ij} + c )}} , {s}_{ij} = 1 - {r}_{ij} , {r}_{ij} = \frac{{Ax}_{i} \cdot {Ax}_{j}}{\vert {Ax}_{i} \vert \vert {Ax}_{j} \vert}$$

, updates the characteristics extraction parameter A and the parameters a, b, c using the predetermined constant α which is given as

$$A ← A - α \frac{\partial {S}^{′}}{\partial A}$$

$$a ← a - α \frac{\partial {S}^{′}}{\partial a}$$

$$b ← b - α \frac{\partial {S}^{′}}{\partial b}$$

$$c ← c - α \frac{\partial {S}^{′}}{\partial c}$$

(Step A8). The constant α is set as a=0.01 concretely.

The pattern matching device judges whether the processing may be finished by the condition that the variable t exceeds to 100 or not, that is, t<=(less-than or equal) 100 or not (Step A9).

The pattern matching device judges that it is not finished because t is less-than or equal 100 for t=1 at the starting point, and increases the variable t by one (Step A10).

And, the characteristics extraction unit 12 executes the characteristics calculation of the Step A5 once again using the characteristics extraction parameter A which is updated in Step A8 and stored in the characteristics extraction parameter storage unit 21. The pattern matching device repeats the processing until the above mentioned processing is judged the finish in Step A9.

Next, the processing in the case of actual matching processing will be described in detail with reference to FIG. 3.

In this description, the case is considered that the facial image data to be actually matched is a pair of two facial image data and whether said two facial image data are the same persons or not is judged. As same as the Step A1, the data registration unit 11 outputs the facial image data as a pair of 6400 dimensions of vectors x⁽¹⁾ and x⁽²⁾ to the characteristics extraction unit 12 (Step B1).

Next, as same as the Step A5, the characteristics extraction unit 12 performs the characteristics extraction processing using the characteristics extraction parameter A stored in the characteristics extraction parameter storage unit 21, and then obtains

z⁽¹⁾=Ax⁽¹⁾

z⁽²⁾=Ax⁽²⁾

### (Step B2).

Next, the distance/similarity ratio calculation unit 13 calculates the normalized correlation value

r=z⁽¹⁾z⁽²⁾/|z⁽¹⁾∥z⁽²⁾|

that is the same similarity ratio which is the processing used in Step A6 (Step B3).

Next, the data matching unit 15 judges whether r is larger than th′ for the predetermined threshold value th′=0.5. And, the result output unit 16 outputs the result that it is the same persons when it is large. Otherwise, the result output unit 16 outputs the result that it is not the same persons (Step B4).

Thus, the pattern matching device according to the example can get the effect that optimizes the subspace.

The reason is because the pattern matching device according to the example can improve the parameters which extract a subspace based on learning according to the distance and the similarity ratio for matching.

While the exemplary embodiments and the examples have been described above, various amendments and changes are possible to the exemplary embodiments and examples without departing from the spirit and scope which are wide range of the present invention defined by the claim for patent.

While the invention has been particularly shown and described with reference to exemplary embodiments and examples thereof, the invention is not limited to these exemplary embodiments and examples. It will be understood by those of ordinary skill in the art that various changes in form and details may be made therein without departing from the spirit and scope of the present invention as defined by the claims.

This application is based upon and claims the benefit of priority from Japanese patent application No. 2009-080532, filed on Mar. 27, 2009, the disclosure of which is incorporated herein in its entirety by reference.

1. A pattern matching device which includes;
a characteristics extraction unit which extracts the characteristics value by dimensional reduction of data using a characteristics extraction parameter,
a calculating unit which calculates a distance or a similarity ratio of the data to be matched using said characteristics value, and
a parameter updating unit which updates the characteristics extraction parameter so that the value of the distance or the similarity ratio may approach to the matching result indicating whether the distance or the similarity ratio is the same category or not, by comparing the distance or the similarity ratio.

2. The pattern matching device according to claim 1,
wherein said parameter updating unit calculates the characteristics extraction parameter updated by performing a maximum likelihood estimation for the posterior probability of judging whether the matched data is the same category or not.

3. The pattern matching device according to claim 2,
wherein said parameter updating unit models the distribution of the distance or the similarity ratio in the same category case and the distribution of the distance or the similarity ratio in the different category case, and uses the criterion which parameterizes the posterior probability by adapting the Bayes's theorem.

4. The pattern matching device according to claim 3,
wherein said parameter updating unit utilizes the gamma distribution as the distribution of the distance or the similarity ratio in the same category case and the distribution of the distance or the similarity ratio in the different category case.

5. The pattern matching device according to claim 3,
wherein said parameter updating unit utilizes the probability density derived based on the assumption that the random value is input to the matched data as the distribution of the distance or the similarity ratio in the case that the matched data is the different category.

6. The pattern matching device according to claim 2,
wherein said parameter updating unit makes the posterior probability the logistic regression whose calculation is made a variable which is the value of the distance or the similarity ratio.

7. The pattern matching device according to claim 1,
wherein said calculation unit calculates the distance or the similarity ratio using the characteristics extraction parameter updated based on said parameter updating unit, and
which includes a matching unit which judges whether it is the same category or not based on the calculated distance or similarity ratio.

8. The pattern matching device according to claim 7,
wherein said matching unit judges whether it is the same category or not according to whether the distance or the similarity ratio reaches a threshold value.

9. A pattern matching method, comprising
extracting the characteristics value by dimensional reduction of data for using a characteristics extraction parameter,
calculating a distance or a similarity ratio of the data to be matched using the characteristics value, and
updating the characteristics extraction parameter so that the value of the distance or the similarity ratio may approach to the matching result indicating whether the distance or the similarity ratio is the same category or not, by comparison of the distance or the similarity ratio.

10. The pattern matching method according to claim 9,
further calculating the characteristics extraction parameter updated by performing the maximum likelihood estimation for the posterior probability of judging whether the matching data is the same category or not.

11. The pattern matching method according to claim 10,
further modeling the distribution of the distance or the similarity ratio in the same category case and the distribution of the distance or the similarity ratio in the different category case, and using the criterion which parameterizes the posterior probability by adapting the Bayes's theorem.

12. The pattern matching method according to claim 11,
further utilizing gamma distribution as the distribution of the distance or the similarity ratio in the same category case and the distribution of the distance or the similarity ratio in the different category case.

13. The pattern matching method according to claim 11,
further utilizing the probability density derived based on the assumption that the random value is input to the matched data as the distribution of the distance or the similarity ratio in the case that the matched data is the different category.

14. The pattern matching method according to claim 10,
further making the posterior probability the logistic regression whose calculation is made a variable which is the value of the distance or the similarity ratio.

15. The pattern matching method according to claim 9,
further calculating the distance or the similarity ratio using the characteristics extraction parameter updated, and
judging whether it is the same category or not based on the calculated distance or similarity ratio.

16. A pattern matching method according to claim 15,
further judging whether it is the same category or not according to whether said distance or similarity ratio reaches a threshold value.

17. A computer readable medium for storing a program to cause a computer to perform:
an extracting process for extracting the characteristics value by dimensional reduction of the data for using a characteristics extraction parameter,
a calculating process for calculating a distance or a similarity ratio of the data to be matched using the characteristics value, and
updating process for updating the characteristics extraction parameter so that the value of the distance or the similarity ratio may approach to the matching result indicating whether the distance or the similarity ratio is the same category or not, by comparison of the distance or the similarity ratio.
